(19) United States
(12) Patent Application Publication
(10) Pub. No.: US 2006/0174506 A1
(43) Pub. Date: Aug. 10, 2006

(54) Oil extraction system

(76) Inventor: Clark J. McDonald, Benson, MN (US)

Correspondence Address: MERCHANT & GOULD PC, P.O. BOX 2903, MINNEAPOLIS, MN, 55402-0903, US

(21) Appl. No.: 11/055,710

(22) Filed: Feb. 9, 2005

(51) Int. Cl. F02B 33/10; F26B 21/06

(52) U.S. Cl. 34/72; 34/468

(57) ABSTRACT

The invention relates to an apparatus and method for vaporizing oil that involves applying heat to an oil-impregnated medium such that the oil therein is vaporized. In one embodiment the apparatus includes a chamber that is constructed to house used oil filters. In this embodiment, heat is applied to the outer surface of the chamber until substantially all the oil therein is vaporized. The resulting oil vapors can be condensed and/or incinerated.

### FIELD OF THE INVENTION

The invention relates to an apparatus and method for extracting oil from a substrate via vaporization.

### BACKGROUND OF THE INVENTION

Processes for extracting oil from a substrate via vaporization are known. In particular, many such apparatuses and methods have been used in the recycling of used oil filters and the oil therein.

Due in part to environmental and economic factors, used oil filters and other oil laden products and materials are generally not buried in landfills; rather, they typically undergo a process whereby the used oil is separated from the used filter. Traditionally, the used oil filters are shredded and the oil is removed from the shredded metal via incineration or a washing process. See, for example, U.S. Pat. No. 5,135,176 to Barber; U.S. Pat. No. 5,832,844 to Schmidt; U.S. Pat. No. 5,366,165 to Jackman; U.S. Pat. No. 5,298,079 to Guymon; and U.S. Pat. No. 5,236,136 to McCarty et al. The washing process can result in large amounts of contaminated wastewater, while the incineration process can result in environmentally unfriendly exhaust gases and ash. Accordingly, both processes potentially raise complicated and expensive issues regarding compliance with state and federal environmental regulations.

More environmentally friendly processes and, consequently, less regulated processes for recycling used oil filters involve the step of vaporizing the used oil in the filters and then subsequently condensing and/or incinerating the vapors. For example, see U.S. Pat. No. 5,401,293 to Gardner; U.S. Pat. No. 5,944,034 to McRae et al.; and U.S. Pat. No. 6,425,957 to McRae. Though oil vaporization processes are known, the currently known processes, including those described in the above-listed patents, are inefficient and typically involve managing an exhaust gas stream that is contaminated with oil vapors. Accordingly, streamlined oil vaporization apparatuses and methods that further decrease the energy and environmental impact associated with the oil vaporization process are needed.

In addition, methods and apparatuses are needed that further decrease the requisite energy consumption and environmental impacts associated with vaporizing spent oil from used oil filters. More specifically, an apparatus and method that provides flexibility for use in other applications, such as to more efficiently extract oil from foods, is needed. For example, oil is typically extracted from soybeans via a relatively complicated chemical process. Accordingly, such a method should provide for simply vaporizing the oil to remove it from the soybeans and then later condense the oil, thereby decreasing production costs. More generally, an apparatus and method for separation of a substrate from a vaporizable material for purification is needed. The vaporizable material can be vaporized out of the substrate, leaving both a purer substrate and a purer vaporizable material. The present invention addresses these problems and others.

### SUMMARY OF THE INVENTION

The invention relates to an apparatus and method for vaporizing a vaporizable material that involves indirectly heating a substance such that the vaporizable material therein is vaporized. For example, in one embodiment, the apparatus includes a chamber that is constructed to house oil-laden substrates such as filters. Heat is applied to the outer surface of the chamber such that the oil therein is vaporized. The vaporized oil escapes through a vent and is channeled to a condenser. Once the chamber is sufficiently cooled, it is opened and oil-free substrates are removed. The chamber is then recharged with oil-laden substrates and the process is restarted.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter in which there is illustrated and described a preferred embodiment of the invention.

### BRIEF DESCRIPTION OF THE DRAWINGS

Referring to the drawing, wherein like reference numbers indicate corresponding elements throughout the several views:

FIG. 1 is a schematic representation of an extraction apparatus according to the principles of the present invention;

FIG. 2 is a schematic representation of an extraction system according to the principles of the present invention;

FIG. 3 is an alternative embodiment of the extraction apparatus of FIG. 1 according to the principles of the present invention; and

FIG. 4 is a flow diagram of an extraction process according to the principles of the present invention.

### DETAILED DESCRIPTION OF THE PREFERRED EMBODIMENT

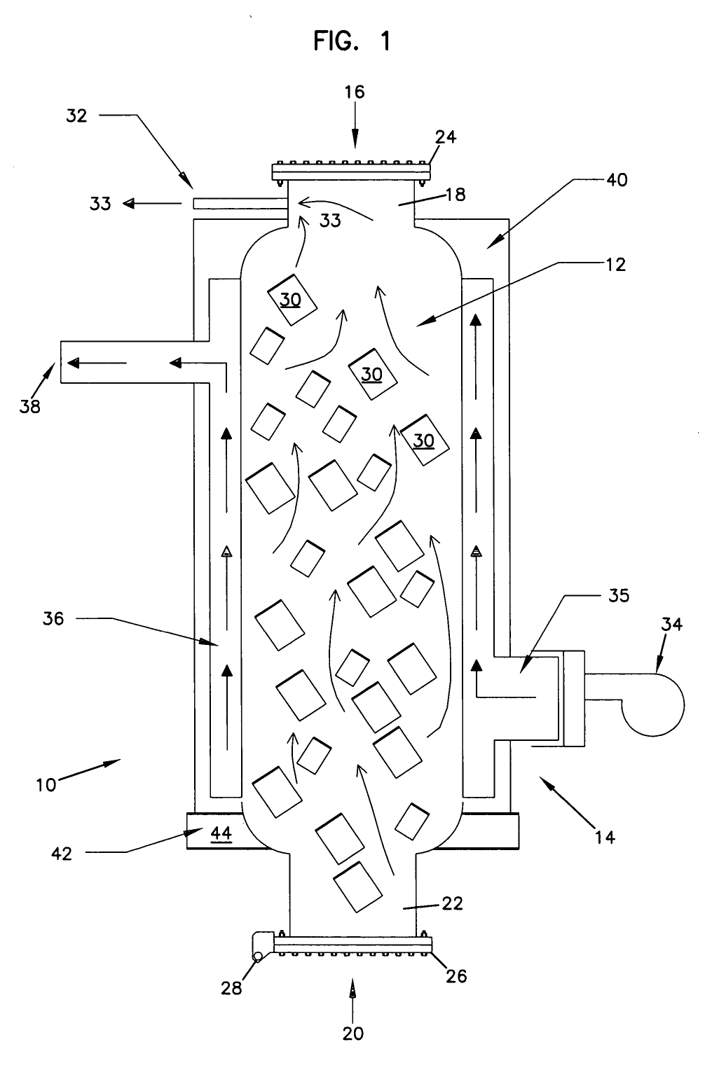

Referring to FIG. 1, a schematic representation of an extraction apparatus 10 is shown. The extraction apparatus 10 includes a chamber 12 for housing substrates, a heating arrangement 14 for heating the chamber 12, and a support structure 42 for supporting the heating arrangement 14 and the chamber 12.

According to the invention, the heating arrangement 14 indirectly heats the chamber 12 causing the gases therein to expand and the vaporizable material therein to vaporize. The expansion of the gases combined with the constant flow of vapor out of the chamber 12 forces enough of the oxygen out of the chamber 12 to prevent combustion inside the chamber 12 even when the chamber 12 is heated to high temperatures. Accordingly, even after all the vaporizable material in the chamber 12 is vaporized, the contents within the chamber 12 remain unburned. In the depicted embodiment where the chamber 12 is filled with oil-laden substrates 30 such as used oil filters, the components of the oil filters (i.e., steel, paper filter media, plastic, rubber, glue and paint) remain essentially intact after the vaporization process. This feature of the invention can be beneficial because the unburned components can be used in a variety of ways including, for example, recycling components for use in the manufacture of other devices or used as fuel to run other processes or machinery. For example, in the depicted embodiment, the rubber gasket seals of the used oil filters can be crushed and used as solid fuel (note that rubber becomes more brittle after the oil therein is vaporized). It should also be understood that indirectly heating the contents in the chamber 12 according to the present invention can provide additional advantages. The term “indirectly heating” as used herein means that the exhaust stream 35 (gas or liquid) of the heating arrangement 14 does not mix with the oil vapors from the chamber 12. This feature is advantageous because the exhaust stream 35 can be vented to the atmosphere or used in other processes without the need to separate the oil vapors 33 therefrom.

In the embodiment shown, the chamber 12 is generally cylindrical in shape and includes a first opening 16 located at a first end 18 and a second opening 20 located at a second end 22. The first opening 16 is commonly referred to as the top opening and the second opening 20 is commonly referred to as the bottom opening. In the depicted embodiment, the first opening 16 is sized and constructed to be used for loading used oil filters or other substrate materials into the chamber 12 and the second opening 20 is sized and configured to unload used oil filters once the vaporization process is completed. Lids 24 and 26 are shown that seal the first opening 16 and second opening 20, respectively. In particular, the lid 26 is shown attached by a hinge 28 to the chamber 12 and the lid 24 is shown attached to the chamber 12 via standard bolts. Both the lids 24 and 26 can include a heat resistant sealing gasket (not shown). The sealing gasket can include, for example, a graphite construction. It should, however, be appreciated that the lids 24 and 26 are not necessarily connected to the chamber 12 via hinges or bolts. In well-known alternative embodiments, the lids 24 and 26 can, for example, be slidably received by the chamber 12 in tracks or grooves.

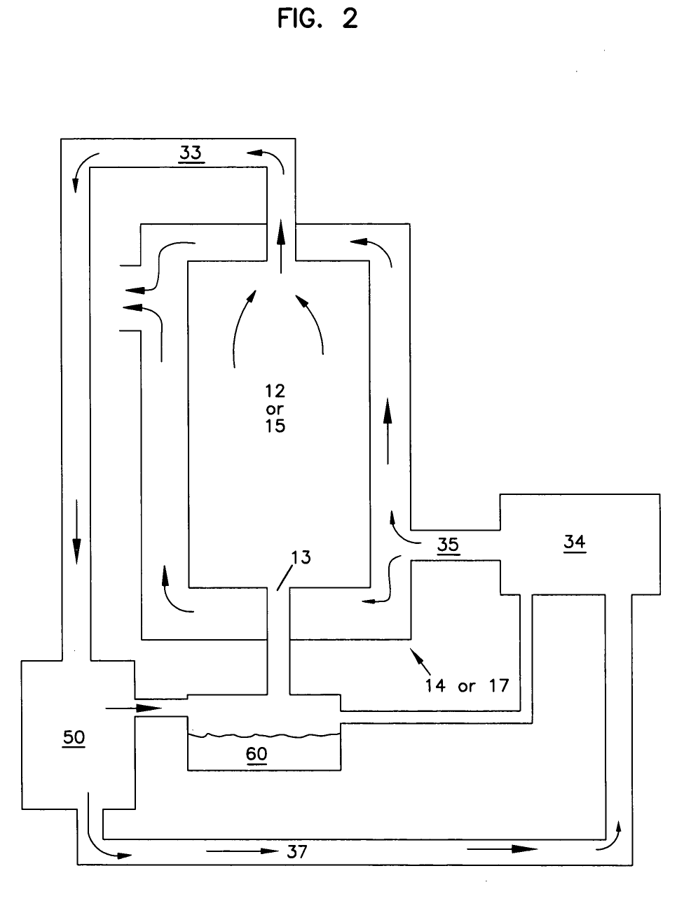

The chamber 12 further includes a vapor vent 32 that is constructed to allow the oil vapors 33 to escape the chamber 12. The vapor vent 32 is shown located at the first end 18 of the chamber. It should be appreciated that the vapor vent 32 can be disposed in many other locations on the chamber 12. For example, in alternative embodiments, the vapor vent 32 could be disposed on the lid 24. Now referring to FIGS. 1 and 2, wherein in some embodiments, the vapor vent 32 leads to a condenser 50 that may be attached to the chamber 12. In such embodiments, the oil vapors 33 can be converted back to a liquid form and stored in an oil tank 60. The condensed oil can be later recycled as oil or used as fuel. The remaining gas stream 37 can be passed through the burner 34 or a secondary incinerator to combust the remaining light end vapors that are not condensed before venting the gas stream 37 to the environment.

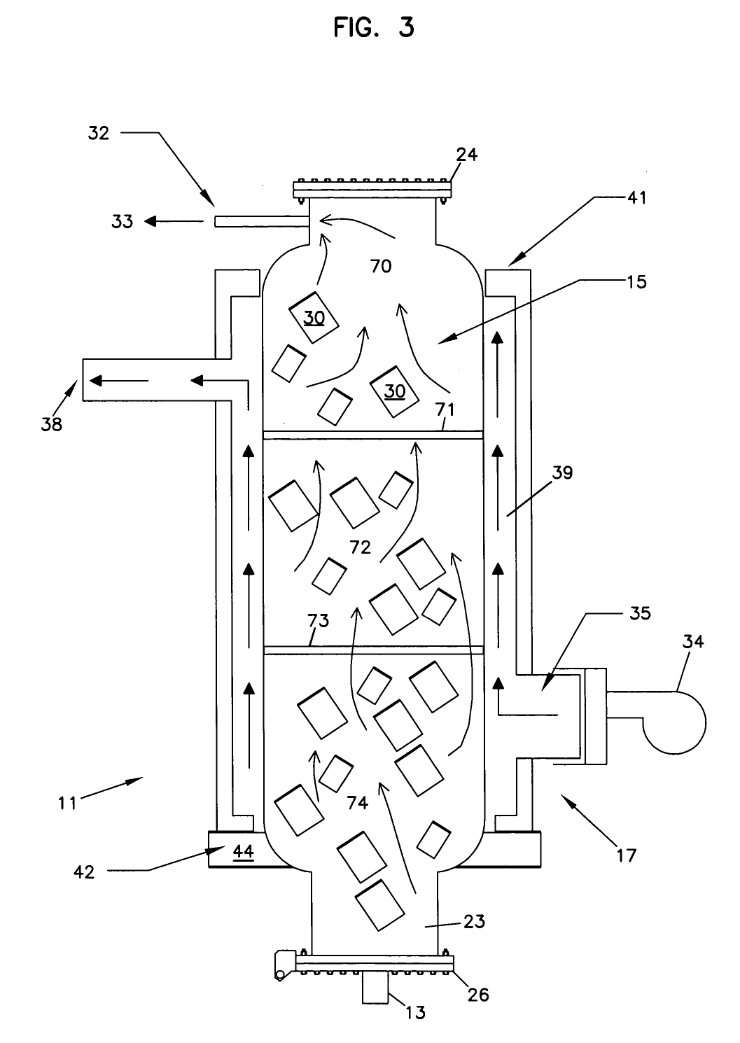

In the embodiment shown in FIG. 1, liquids can be drained by partially opening the lid 26 at the second end 22 of the chamber 12. In the embodiments shown in FIGS. 2 and 3 a chamber 15 includes a drain 13 to allow liquids to escape the chamber 15 and into the oil tank 60. The drain 13 can be disposed, for example, at the second end 23 of the chamber 15. In the embodiment shown in FIG. 3, the extraction apparatus 11 includes a chamber 15 having a number of sections 70, 72, and 74 separated by wire meshes 71 and 73, wherein each of the sections 70, 72, and 74 includes at least one opening 24, 26 for loading and unloading the chamber 15. As shown in FIGS. 1-3, it should be understood that both the chambers 12 and 15 may be of many other configurations. Instead of having a generally cylindrical shape, the chambers 12 and 15 could have, for example, a rectangular or a circular shape. In addition, there could be less or more openings 24 and 26 to the chamber 12 or 15. For example, in some embodiments, there is only one opening and the chamber 12 or 15 is constructed to rotate so that the substrates 30 can be easily loaded into the chamber 12 or 15 and also easily dumped out the chamber 12 or 15 once the vaporization process is completed

Referring back to FIG. 1, an embodiment of a heating arrangement 14 is shown. As briefly discussed above, the heating arrangement 14 is constructed to elevate the temperature in the chamber 12 without directly contacting the heating medium (shown as a gas stream 35) with the oil-laden substrates 30 in the chamber 12. In the depicted embodiment, the heating arrangement 14 includes a burner 34, a hot gas jacket 36, an exhaust vent 38, and an insulator 40. The burner 34 can be any conventional burner that is capable of producing temperatures sufficient to cause oil vaporization. In the embodiment shown, the burner 34 is capable of heating the air outside the chamber 12 to temperatures as high as 2400° F. However, to avoid melting or unnecessarily fatiguing components of the extraction apparatus 10, the temperature within the chamber 12 is less than 1600° F. and, more preferably, less than 1000° F. It should, however, be understood that vapor from volatile materials including, for example, gas, diesel, which are commonly found on or in the oil filters may be generated at much lower temperatures.

As referenced above, the heating arrangement 14 of the depicted embodiment includes a hot gas jacket 36 adjacent to the outer surface of the chamber 12. The hot gas jacket 36 preferably surrounds a substantial portion or even the entire chamber 12 to provide a consistent temperature within the chamber 12. An exhaust vent 38 is also provided that enables the exhaust stream 35 that passes over the exterior surface of the chamber 12 to escape and be replaced with fresher and hotter gas from the burner 34. Disposed around the hot gas jacket 36 is an insulator 40. The insulator 40 is constructed to maintain the temperature of the gases around the chamber 12 to prevent heat waste. In the depicted embodiment, the insulator 40 defines the shape of the hot gas jacket 36 and thereby aids in channeling the flow of the exhaust stream 35 so that the exhaust stream 35 is not mixed with the oil vapors 33.

Though in the depicted embodiment, the hot gas jacket 36 and the insulator 40 are show connected to the chamber 12, it should be appreciated that many other configurations are possible. For example, as shown in FIG. 3, the chamber 15 can be movable with respect to a heating arrangement 17. In the embodiment depicted in FIG. 3, the hot gas jacket 39, insulator 41, and burner 34 together form an oven. The chamber 15 of the extraction apparatus 11 is constructed to be inserted into the oven for heating and removed from the oven for cooling. In some embodiments, water is sprayed on the chamber 15 once it is removed from the oven to facilitate cooling and decrease cycle time.

Referring to FIGS. 1 and 3, the extraction apparatuses 10 and 11 further include a support frame 42 for supporting the chambers 12 and 15 and the heating arrangements 14 and 17. In the embodiment shown, the support frame 42 includes a beam 44 that mounts to the chamber 12 or 15. The beam 44 can be anchored to the floor, wall, or any structure (not shown). In the embodiment shown in FIG. 1, the beam 44 holds the chamber 12 in a stationary position. Whereas in the embodiment shown in FIG. 3, the chamber 15 is movably supported by the beam 44. According to the embodiment shown in FIG. 3, the beam 44 can be connected to an arm (not shown) that indexes the chamber 15 into the oven and removes the chamber 15 from the oven after a particular set time period. In other alternative embodiments the support frame 42 supports the chamber 12 or 15 such that the chamber 12 or 15 can rotate about one or more axes.

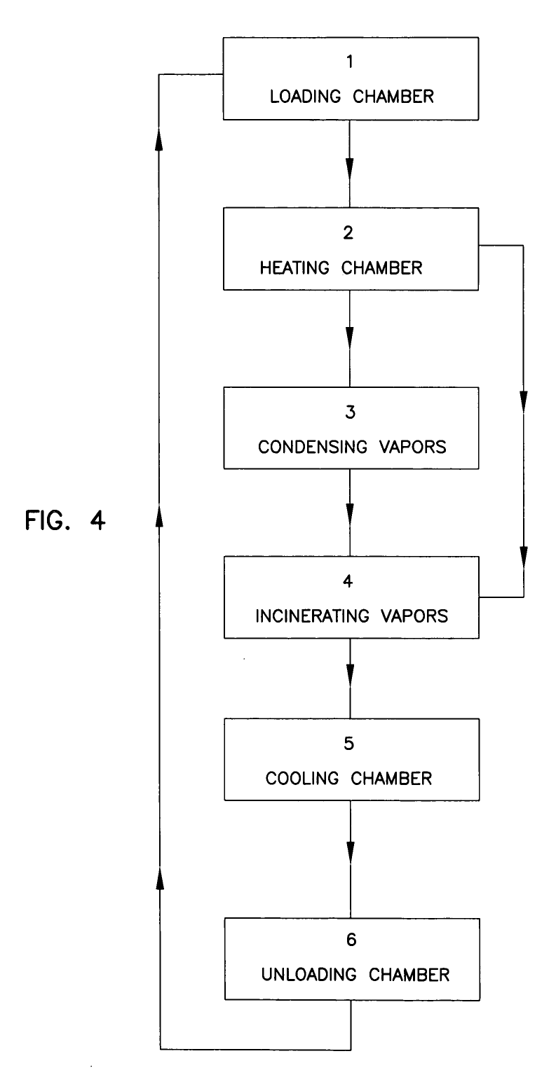

Referring to FIG. 4, the invention is also directed to a method of extraction via vaporization. The method involves the step of loading 1 substrates into a chamber 12 or 15. The substrate can be anything with a vaporizable material therein. For example, the substrate can include used oil filters, rubber tires, soybean material, mercury contaminated materials, or lignite. The method further includes the step of heating 2 the chamber 12 or 15 to a sufficiently high temperature to cause the material in the substrates 30 to drain out and/or vaporize out. The step of heating 2 may include decreasing the oxygen concentration within the chamber 12 or 15 to prevent combustion within the chamber 12 or 15.

In some embodiments, the method also includes some additional steps. Some embodiments include the steps of collecting and condensing the vapors 3 and/or incinerating 4 the vapor stream 33. Other embodiments include the steps of cooling 5 the chamber 12 or 15, unloading 6 the chamber 12 or 15, and recharging chamber 12 or 15 with new substrates having vaporizable material therein.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An oil vaporizing device comprising:
a chamber having an interior for housing oil impregnated substrates;
an insulated body including a cavity constructed to surround at least a portion of the chamber, the cavity configured to circulate hot fluid around an exterior of the chamber;
wherein the chamber and the insulated body are constructed such that hot fluid in the cavity is isolated from the interior of the chamber.

2. The oil vaporizing device according to claim 1, further comprising a condenser in fluid communication with the chamber.

3. The oil vaporizing device according to claim 1, further comprising a heat source for generating hot fluid, wherein the hot fluid is in fluid communication with the cavity.

4. The oil vaporizing device according to claim 1, wherein the chamber includes a frame member for supporting the chamber in a stationary position.

5. The oil vaporizing device according to claim 1, wherein the chamber includes a cylindrical shape with a first end, a second end, and a mid-portion therebetween, and wherein at least one of the ends includes an opening.

6. The oil vaporizing device according to claim 5, wherein the insulating body surrounds the mid-portion of the chamber.

7. The oil vaporizing device according to claim 6, wherein the insulating body includes an inlet and an outlet, wherein the outlet provides a vent for oxygen and other gasses within the chamber to escape to the surrounding environment.

8. The oil vaporizing device according to claim 5, wherein the chamber includes a first lid for an opening at the first end and a second lid for an opening at the second end.

9. The oil vaporizing device according to claim 1, further comprising a condenser and a burner, wherein the burner and the condenser are in fluid communication with the chamber and the cavity, wherein the condenser is disposed intermediate the chamber and the burner.

10. A method for removing oil from a substrate comprising the steps of:
circulating hot fluids across an exterior surface of a chamber until vapors are formed therein, wherein the chamber houses at least some substrate material; and
directing the vapors out of the chamber while isolating the circulating hot fluids from an interior of the chamber.

11. The method according to claim 10, further comprising the step of containing and condensing the vapors.

12. The method according to claim 11, wherein the substrate material comprises soybean material.

13. The method according to claim 10, wherein the substrate material comprises used rubber tires.

14. The method according to claim 13, further comprising the step of removing the rubber tires and crushing the tires into smaller component parts.

15. The method according to claim 10, wherein the substrate material comprises used oil filters.

16. The method according to claim 10, further comprising the step of spraying water on the chamber.

17. The method according to claim 10, further comprising the step of heating the interior of the chamber to about 500 to 1000° F.

18. The method according to claim 10, further comprising the step of channeling the vapors from the chamber through a condenser and subsequently through a burner.

19. The method according to claim 10, further comprising the step of draining liquids from the chamber.

20. The method according to claim 10, further comprising the step of regulating the concentration of oxygen within the chamber.

21. A used oil filter dryer comprising:
a chamber for housing used oil filters, the chamber including a vapor vent;
an insulated body including a cavity, wherein the cavity includes a hot fluid jacket that at least partially encloses a portion of the chamber;
wherein the chamber is constructed such that hot fluids in the cavity are isolated from an interior of the chamber.

22. The used oil filter dryer according to claim 21, further comprising a condenser in fluid communication with the vapor vent.

23. The used oil filter dryer according to claim 21, further comprising a heat source for generating hot fluid, wherein the hot fluid is in fluid communication with the cavity.

24. The used oil filter dryer according to claim 21, wherein the chamber includes a frame member for supporting the chamber in a stationary position.

25. The used oil filter dryer according to claim 21, wherein the chamber includes a cylindrical shape with a first end, a second end, and a mid-portion therebetween, and wherein at least one of the first and second ends includes an opening.

26. The used oil filter dryer according to claim 25, wherein the insulating body surrounds the mid-portion of the chamber.

27. The used oil filter dryer according to claim 21, wherein the insulating body includes an inlet and an outlet, wherein the outlet is constructed to provide a vent to the surrounding environment.

28. The used oil filter dryer according to claim 25, wherein the chamber includes a first lid for an opening at the first end and a second lid for an opening at the second end.

29. The used oil filter dryer according to claim 21, further comprising a condenser and a burner both in fluid communication with the chamber, wherein the condenser is disposed intermediate the chamber and the burner.

30. The used oil filter dryer according to claim 21, wherein the chamber is mounted to an arm that is constructed to move the chamber into or out of the cavity.

31. The used oil filter dryer according to claim 23, wherein the burner is configured to use oil from the used oil filters as fuel.
